(19) United States
(12) Patent Application Publication
(10) Pub. No.: US 2005/0205107 A1
(43) Pub. Date: Sep. 22, 2005

(54) Dental floss head device with a flavor delivery means

(76) Inventor: Harold D. Ochs, Flemington, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/805,737

(22) Filed: Mar. 22, 2004

(51) Int. Cl. A61C 15/00

(52) U.S. Cl. 132/323

(57) ABSTRACT

An improved dental floss device, having a new method of delivering flavor and actives to the oral cavity. The dental floss device consists of a dental floss holder and a handle, which are coupled together for a snap-fit connection. The dental floss holder having the floss insert molded in, contains at least one cavity that can be filled with flavors and/or chemotherapeutic agents. Saliva from the user's mouth activates the release of the soluble flavor agent as well as the chemotherapeutic agents, when the floss is passed between teeth. The cavity may also be subdivided to allow for substances that would normally react with each other to be mixed as the flossing device is being used.

### BACKGROUND OF THE INVENTION

1. Field of the Invention

The present invention relates to a dental floss device that is adapted to deliver flavor and/or chemotherapeutic agents to the mouth.

2. Description of the Prior Art

The desire for adding flavor to the mouth and teeth while flossing has lead to the development of flavored dental floss coatings. Dental flosses having flavoring applied directly to the floss are well known in the art. In use, flavored dental floss is inserted between teeth. The dental floss leaves a light flavoring in the mouth as the floss is passed between teeth.

Flavored dental floss is typically packaged and sold in lots of twenty-four or thirty-six units. The process for making flavored dental floss typically involves placing a traditional flavor system including flavor such as spray dried flavor in a coating such as a microcrystalline wax, then applying the coating to a fiber substrate to generate a dental floss. Dental floss holders have recently become a popular way of flossing between teeth. If these wax-coated dental flosses are used in an injection molding process for making dental floss holders, the coating will eventually clog the injection mold and cause the molding machine to jam. Furthermore, the amount of flavor available is small and thus only a hint of flavor can be provided through this technique.

U.S. Pat. No. 5,165,913 discloses A CONTROLLED RELEASE INTERPROXIMAL DELIVERY SYSTEM, wherein the dental floss contains surfactant and silicone preparations with added chemotherapeutic agents. Unlike the present invention, the '913 patent provides flavor only to the floss, allowing for just a small amount of flavoring to be inserted into a user's mouth.

In U.S. Pat. No. 6,591,844, ELASTOMERIC MONOFILAMENT DENTAL TAPES are disclosed. In the '844 patent dental tape has saliva soluble coatings, which are directly on the floss. By contrast, the present invention has a floss head device with floss extending there-between, wherein the head device contains cavities, which hold a larger amount of flavoring.

In another U.S. Pat. No. 5,098,711, a METHOD OF TREATING THE ORAL CAVITY WITH DENTAL FLOSS CONTAINING CHEMOTHERAPEUTIC AGENTS is disclosed. In the '711 patent, the dental floss uses a surfactant, silicone and chemotherapeutic agent, which are released from the dental floss unlike the present invention's release mechanism, delivering only a small amount of flavoring and/or other chemicals.

Dental floss devices with flavoring or chemicals attached to the floss itself are difficult to process and only deliver a small amount of flavoring. The provision of a flavored dental floss device head would simplify processing and would improve flavor delivery to a user's mouth. None of the above inventions and patents, taken either singly or in combination is seen to describe the instant invention as claimed. Therefore, there is a need for a dental floss head device having an improved flavor-delivery feature.

### SUMMARY OF THE INVENTION

In accordance with a first embodiment of the present invention there has been provided a dental floss device including a handle having a head portion and a flavored dental floss holder, which is adapted to be releasably connected to the head portion for subsequent use. The dental floss device further comprises releasable engagement means for releasably securing the dental floss holder to the handle during use. The head portion extends transversely of the longitudinal axis of the gripping portion, as a result of which the handle has a generally T-shaped configuration. The head portion includes a generally U-shaped channel for releasably receiving the above-described dental floss holder. The U-shaped channel comprises a floor and two spaced apart walls. A first of the two walls comprises at least one protrusion and at least one indentation spaced laterally therefrom. The second of the two walls defining the U-shaped channel also comprises at least one protrusion and at least one indentation spaced laterally therefrom. The protrusion on the first of the two walls is located opposite the indentation on the second of the two walls. The indentation on the first of the two walls is located opposite the indentation on the second of the two walls. The indentation on the first of the two walls is located opposite the protrusion on the second of the two walls. The protrusions and indentations on the two walls defining the U-shaped channel of the head portion are sized and arranged to receive in frictional engagement the indentations and protrusions on the lateral sides of the base portion of the aforementioned dental floss holder. The dental floss holder has a base portion and a pair of spaced-apart arms extending from the base portion to accommodate a length of dental floss therebetween. The base portion comprises a pair of lateral sides. Each lateral side comprises at least one protrusion and at least one indentation spaced laterally therefrom. The protrusion on the first lateral side is located opposite the indentation on the second lateral side. The indentation on the first lateral side is located opposite the protrusion on the second lateral side. Preferably, the spaced-apart arms include snap fit projections for engagement with the head portion of the handle. The spaced-apart arms have snap fit projections extending inwardly there from. Each of the spaced-apart arms has at least one cavity defined therein. Each cavity may consist of a through hole or a concavity capable of holding flavoring and/or actives. In use, the floss holder is attached to the handle at its head portion, a user would then place the floss holder portion in their mouth to begin flossing. Once the floss from the floss holder is inserted between the user's teeth and saliva contacts the flavoring and/or actives stored in each arm's cavity, the flavoring and/or actives will disperse throughout the user's mouth.

In accordance with a second embodiment of the present invention, there has been provided a dental floss device having a dental floss holder and handle. The dental floss holder comprises a base portion and a pair of spaced-apart arms extending from the base portion to accommodate a length of dental floss there between. At least one of the spaced apart arms has at least one cavity defined therein. Each cavity may consist of a through hole or a concavity capable of containing flavoring and/or actives. The base portion comprises a pair of lateral sides. The handle integrally extends from the base portion of the dental floss holder. In use, the floss holder has an integrally attached handle at its base portion, a user would then place the floss holder portion in their mouth to begin flossing. Once the floss from the floss holder is inserted between the user's teeth and saliva contacts the flavoring and/or actives stored in each arm's cavity, the flavoring and/or actives will disperse throughout the user's mouth.

In accordance with another embodiment of the present invention, there has been provided a dental floss holder device comprising a base portion and a pair of spaced-apart arms extending from the base portion. A length of dental floss is secured between the distal ends of the spaced-apart arms. The base portion comprises a pair of lateral sides and may optionally further comprise means for releasable engagement for attachment to a handle. Each lateral side may comprise of at least one protrusion and at least one indentation spaced laterally therefrom. The protrusion on the first lateral side is located opposite the indentation on the second lateral side. The indentation on the first lateral side is located opposite the protrusion on the second lateral side. At least one of the spaced-apart arms has a cavity. The cavity can be a through hole or a concaved area and is adapted to contain a flavoring and/or an active loaded therein. Once flossing begins flavoring and/or actives will disperse throughout the mouth as each cavity filled with flavoring contacts saliva from the user's mouth.

In accordance with another embodiment of the present invention, there has been provided a dental article having means for delivering a flavor and/or a chemotherapeutic substance to the oral cavity in use, said article being formed from an injection molded plastic, said article having at least one cavity, said at least one cavity being filled with a heat meltable polymer which is solid at room temperature and capable of melting when placed in the mouth and contacted with saliva whereby said flavor and/or chemotherapeutic substance is delivered to the oral cavity.

### BRIEF DESCRIPTION OF THE DRAWINGS

FIG. 1 is an exploded perspective view of one embodiment of a dental floss holder device in accordance with the present invention;

FIG. 2 is a perspective view of the dental floss holder in FIG. 1, in accordance with the present invention;

FIG. 3 is a front view of a dental floss holder device in accordance with the present invention;

FIG. 4 is a rear view of the dental floss holder in accordance with the present invention;

FIG. 5 is another embodiment of FIG. 3 in accordance with the present invention;

FIG. 5A is a cross-sectional view of FIG. 5 at line 5A-5A; and

FIG. 6 is another embodiment of FIG. 4 in accordance with the present invention.

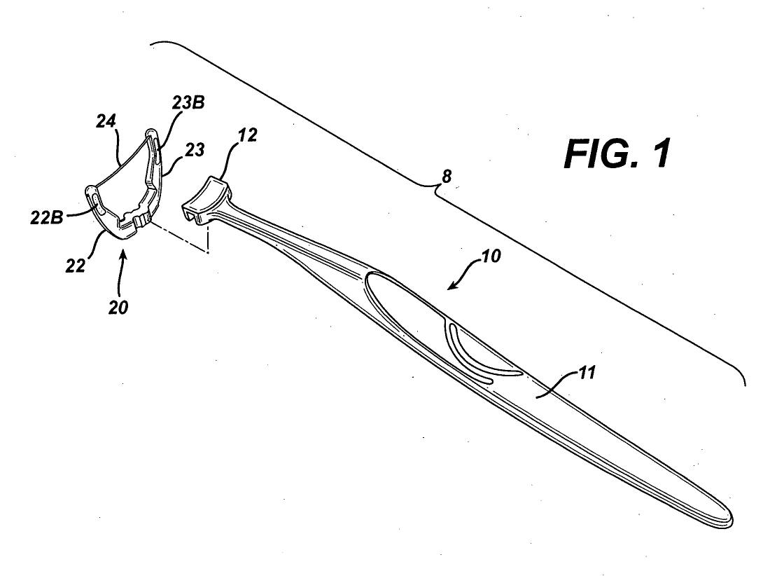

### DETAILED DESCRIPTION OF PREFERRED EMBODIMENTS

The present invention is directed to a dental floss device having a base portion; and a pair of spaced-apart arms extending from the base portion to accommodate a length of dental floss therebetween. Each of said pair of spaced-apart arms has a surface and the surface of at least one of said arms is provided with a cavity capable of containing a flavored substance, an active or a combination of a flavored substance and an active. In one embodiment of the invention, the dental floss device includes a handle and a dental floss holder. The handle and dental floss holder may be formed as an integral, unitary structure or alternatively, the dental floss holder may be separable from the handle and formed as discrete units. When the dental floss holder is formed as a discrete unit, it is preferably stackable, that is, easily capable of being stacked, one on top of an adjacent unit in substantially parallel fashion.

The handle and flavored stackable dental floss holder comprising the dental floss device of the present invention may be made of any suitable material known in the art. Suitable materials include polymers such as, but not limited to, acrylics, such as poly methyl methacrylate; polyolefins, such as polyethylene and polypropylene; polyesters, such as polycaprolactone; co-polyesters; polycarbonate; and mixtures thereof.

The handle and dental floss holder may be made of the same material or different materials. Preferably, the flavored dental floss holder (exclusive of the dental floss material) is made of a material that is softer than the material from which the handle is made. In a preferred embodiment, the dental floss holder is made from a polypropylene material and the handle is made of co-polyester material.

The handle and stackable dental floss holder of the present invention may be made by any suitable process known in the art. Injection molding is preferred.

The flavored dental floss holder includes two spaced-apart arms having at least one cavity positioned thereon. Each cavity can be extended through the arm or closed to one side. In use, each cavity contains flavoring and/or chemotherapeutic agents therein. The shape of the cavity is not critical and may be in the form of a square, circle, triangle or any shape formed therein. The cavity will preferably contain mechanisms that will help retain a flavor system in place. These will typically be a roughened surface (in contrast to a smooth surface), protrusions extending into the cavity or above the cavity for keeping the flavor system from becoming loose within the cavity, or in the case where the cavity is closed on one side, through holes extending from the underside surface of the cavity through to the other side of the floss holder. The holes preferably contain a tapered section that increases in diameter as you move away the cavity surface. This way when melted material flows into the hole and solidifies, a lock will be formed which holds the flavor system in place. The dental floss holder retains a length of dental floss for cleaning between teeth. Any dental floss material known in the art may be used in the dental floss holder of the present invention. The dental floss material may be a monofilament or a multi-filament yarn comprising a plurality of such monofilaments.

Flavoring in the form of a water soluble or water insoluble substance may be filled into the cavity of the floss holder's arms. The substance would be water soluble preferably, in which flavor droplets, sweeteners and actives are dispersed. The substance may also contain commercially available spray dried flavors. Suitable water soluble substances include, but are not limited to, polyethylene glycols (such as PEG 1000 to PEG 5000), ethylene oxide/propylene oxide copolymers, such as those commercially available under the trade name PLURONIC®, and polyvinyl alcohols. These substances may be heated and flavor oil may be added to homogenized the flavor system. This homogenization breaks up the flavor into droplets and disperses it into the substance. The substance and flavor droplets may be filled into the cavity(s) of the arms where it may cool, solidify and bond. Suitable water insoluble substances include, but are not limited to, an emulsion of oil and water soluble substances with flavor immersed therein and microcrystalline wax. The water insoluble substance preferably has a low melting point, e.g., below 180 degrees F. and more preferably, e.g., below 140 degrees F. Typically, spray dried flavor is used in conjunction with insoluble substances. It should be noted that water insoluble substances yield low flavor delivery when used this way. The water soluble or insoluble substance flavorant is generally known as a flavor system.

An “active”, as used herein, may be any agent that is capable of delivering a health or cleansing benefit to the oral cavity. In a preferred embodiment the active is a chemotherapeutic agent. Suitable chemotherapeutic agents include, but are not limited to, anti-microbials of ionic and non-ionic such as alkyl trimethyl ammonium bromide, chlorohexisdenine, sanguinaria, triclosan, zinc sulfate, antibiotics such as tetracycline, antioxidants desensitizers such as potassium nitrate, remineralizing agents such as compounds of fluoride such as sodium fluoride or stannous fluoride, anti-tartar agents such as tetra sodium pyrophosphate (TSPP), plaque control agents such as cetyl pyridinium chloride, cleaning substances such as surfactants and emulsifiers such as sodium lauryl sulfate, sodium lauryl sacosinate, surfactants such as block co-polymers, coating substances such as silicones, carbowaxes, silicone glycol copolymers and polydimethylsiloxane teeth whitening and bleaching agents such as calcium peroxide, pH buffering agents such as buffered or acidulated phosphofluoride, sodium monofluorophophate antifungal agents and hemostatic agents such as vitamin K and calcium ions in the form of water-soluble calcium salts.

Dental flosses in the form of a multi-filament yarn may be circular in cross section or flat, and typically have a denier ranging from about 200 to about 1400. The denier of the individual fibers typically ranges from about 1 to about 6, although other deniers may be used in some circumstances if desired. The yarn may be twisted or untwisted as well as coated with substances to prevent fraying and provide ease of sliding between teeth.

Psuedo-monofilament yarns may also be used as dental floss material in the present invention. Pseudo-monofilament yarns are made by extruding bi-component fibers, each fiber comprising a core of one polymer and a sheath of a different polymer, then either partially or totally melting the sheaths of the fibers to bond or fuse the fibers, resulting in a monofilament look and feel. One example of a suitable bi-component fiber for making pseudo-monofilament yarn is a core of nylon 6 with a sheath of PEBAX® brand polyether/amide copolymer. Other materials besides nylon can be used for the core of the bi-component fibers and other polymeric materials besides polyether/amide copolymer may be used as the sheath material.

Other dental floss materials which may be used in the present invention include, but are not limited to, nylon 6-6, nylon 6, polypropylene, polyethylene, high molecular weight polyethylene, ultra high molecular weight polyethylene, monofilament polytetrafluoroethylene, and the like materials. Combinations of such materials are also acceptable as long as they provide the floss with strength and resistance to fraying. Ultra high molecular weight polyethylene is a preferred dental floss material.

The individual monofilaments comprising a multifilament dental floss yarn may, if desired, be air entangled. If the yarn is air entangled, the air entanglement nodes may be from about 1.25 cm to about 5.2 cm apart, preferably from 2 cm to 3 cm apart. One type of air entangled yarn is described in U.S. Pat. No. 5,908,039, the disclosure of which is hereby incorporated by reference.

As is known in the art, the dental floss may be twisted. If the dental floss is twisted, it is preferable to have less than 6 turns per 2.54 cm, and more preferably less than 5 turns per 2.54 cm.

As is known in the art, the dental floss may be coated with waxes, flavorants, active ingredients, and the like.

The disclosure of U.S. Pat. No. 5,538,023 to Oczkowski et al. is incorporated herein by reference, wherein one process of manufacturing dental floss holders, includes feeding dental floss through a multi-cavity mold and injecting plastic into the mold to form the holders. After completion of the injection-molding step, the floss may then be cut and tied at the ends. Alternatively, the ends are heated to form spheres and retain the floss material in place. The floss in the dental floss holder typically has some slack. In use, it is preferred that the dental floss be taut.

The relationship between the snap fit projections on the dental floss holder and the terminal snap fit recessions of the head portion may be adapted to make the floss material taut when the dental floss device is assembled for use. The length of the head portion is sized so that when the dental floss holder is secured in the U-shaped channel of the head portion, the distance between the arms of the dental floss holder is increased, thus making the floss material taut. The distance by which the arms of the dental floss holder is increased when the dental floss holder is brought into engagement with the head portion of the handle depends on the amount of slack in the dental floss material when the dental floss holder is out of engagement with the head portion. Typically, this distance ranges from about 0.005 inch to about 0.06 inch, preferably from about 0.01 inch to about 0.02 inch.

Examples are provided below to further illustrate the dental floss devices of the present invention. The invention should not be construed as being limited to the specific details set forth herein.

### EXAMPLE 1

### Handle

A co-polyester handle according to the present invention was made by injection molding. Referring now to the appended drawings, handle 10 comprises an elongated gripping portion 11 and a head portion 12 at its distal end. Head portion 12 extends transversely of the longitudinal axis of gripping portion 11, as a result of which handle 10 has a generally T-shaped configuration. Head portion 12 includes a generally U-shaped channel for releasably receiving a dental floss holder of the type mentioned hereinabove and in Example 2. The U-shaped channel comprises a convex floor 14 and two spaced apart walls, 16 and 18. First wall 16 comprises a protrusion 16A and an indentation 16B spaced laterally therefrom. Second wall 18 defining the U-shaped channel comprises a protrusion 18A and an indentation 18B spaced laterally therefrom. Protrusion 16A on first wall 16 is located opposite indentation 18B in second wall 18. Indentation 16B on first wall 16 is located opposite protrusion 18A on second wall 18. Protrusions 16A, 18A and indentations 16B, 18B on walls 16, 18 are sized and arranged to receive in frictional engagement mating indentations and protrusions on lateral sides 25, 26 of base portion 21 of the aforementioned dental floss holder 20. See also Example 2 hereinafter. Sides 13, 15 of head portion 12 engage snap fit projections 27A, 27B of dental floss holder 20 when the floss device is assembled for use.

### EXAMPLE 2

### Flavored Dental Floss Holder

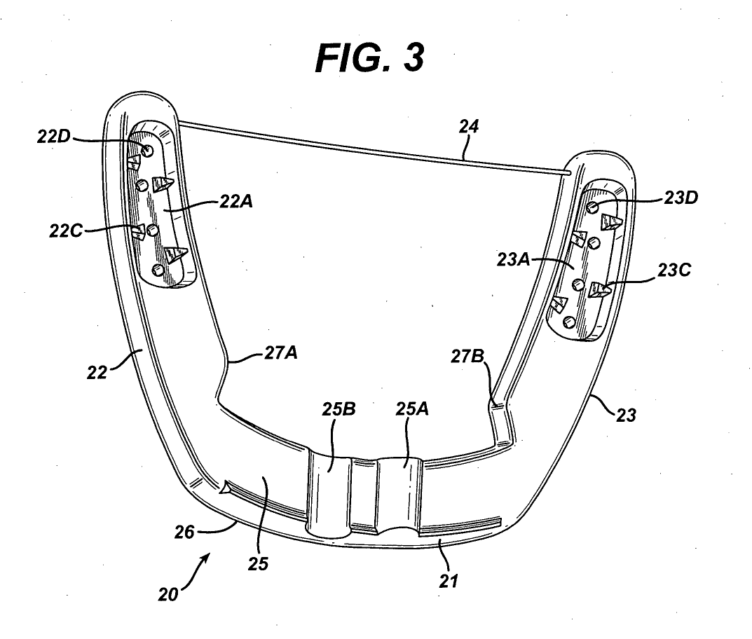

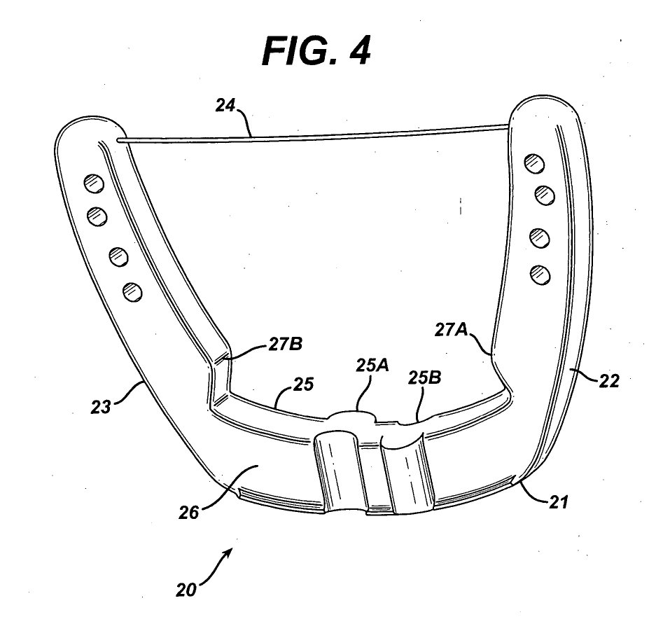

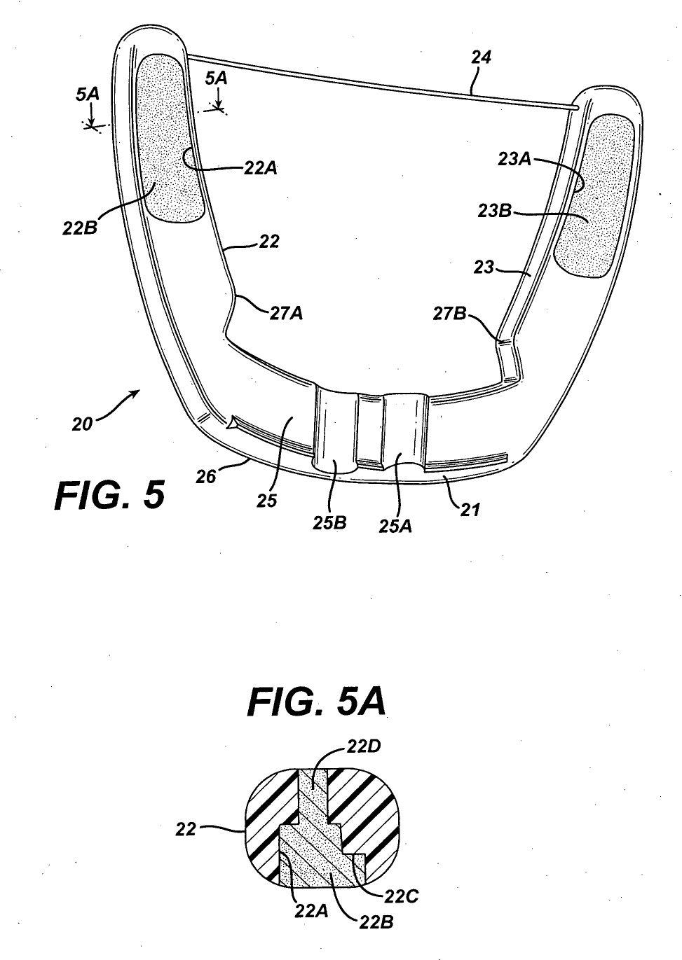

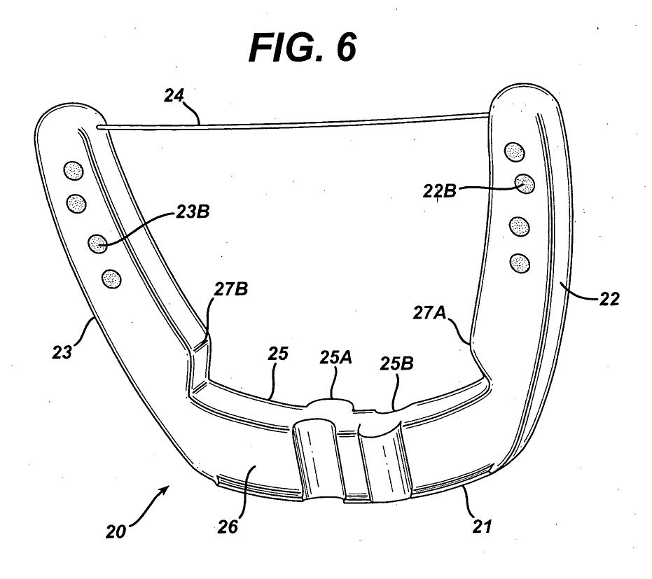

A polypropylene flavored dental floss holder according to the present invention was made by injection molding with Eastman EASTAR® BR003 co-polyester. As is seen in FIG. 3, dental floss holder 20 comprises a base portion 21 and a pair of spaced-apart arms 22 and 23 extending from the base portion to accommodate a length of dental floss 24 therebetween. Base portion 21 comprised a pair of lateral sides 25, 26. Lateral side 25 comprised a protrusion 25A and an indentation 25B spaced laterally therefrom. Protrusion 25A on first lateral side 25 was located opposite indentation 26B on second lateral side 26. The indentation 25B on first lateral side 25 was located opposite protrusion 26A on second lateral side 26. The spaced-apart arms included snap fit projections 27A, 27B for engagement with sides 13, 15 of head portion 12 of handle 10. The spaced-apart arms 22 and 23 also had at least one cavity 22A, 23A defined therein for containing a flavoring and/or actives 22B, 23B. Each cavity 22A, 23A contains protrusions 22C, 23C and through holes 22D, 23D placed therein. The floss holder was machined out to provide each cavity with approximately 1/32″ wide, by 1/16″ deep and ⅜″ long extending proximate the line where the floss passed through the head upward along the centerline of the floss holder. The dental floss 24 was 435 denier SPECTRA® Fiber 1000 ultra high molecular weight polyethylene, available through Honeywell Incorporated. The cavities were filled with various flavor formulations such as PEG 3350 (68%), H&R spray dried flavor #813581 (28%) and sodium saccharin (4%). Approximately 0.030 grams of flavor were loaded into the cavities. The loading of 0.030 grams of flavor formulation is 40 times greater than what could be delivered from the ¾″ length of floss in the head using a conventional delivery system. The cavities were filled by hand, where a spatula was dipped into a melted formula and manually placed into the cavity. The cavities may also be filled by using a mechanized system where miniature pistons pump in the exact amount of flavor into the cavity via a heated nozzle system. The cavity's volume may be at least 0.00521885 cu. in., more preferably the volume may be 0.00104377 cu. in.

### EXAMPLE 3

### Dental Flossing Device

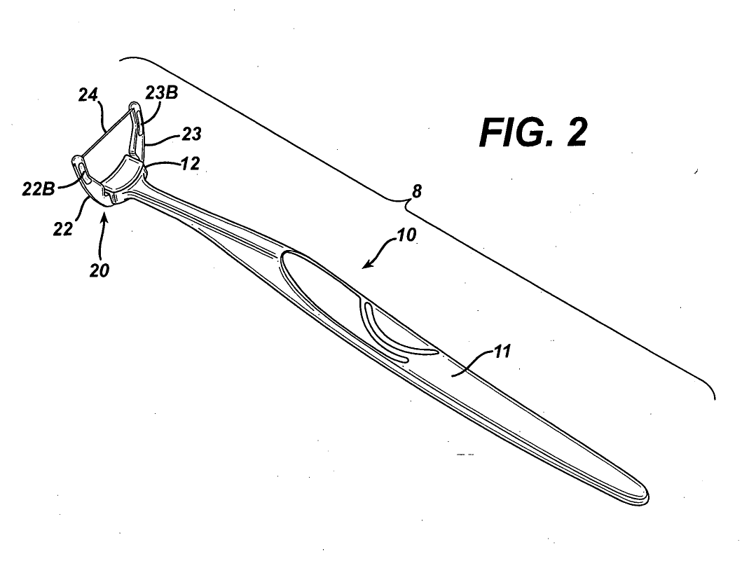

A dental flossing device was assembled by placing the cavity flavored-filled dental floss holder of Example 2 in the head portion of Example 1. The dental flossing device is shown in FIG. 2. The detents of the head portion receive the recesses of the dental floss holder. The recesses of the head portion receive the detents of the dental floss holder. The terminal snap fit recessions of the head portion receive the snap fit projections of the dental floss holder.

### EXAMPLE 4

### Flavored Dental Floss Device in Use

The dental floss device of example 3 was assembled and placed in use. The dental floss holder was then given to individuals for an initial trial. The results showed a continuous flavor burst throughout the mouth during flossing of all the teeth. This result further shows that saliva does indeed activate the flavor system to deliver a strong flavor perception. It was found that blending the molecular weights of the polyethylene glycols used as the soluble substance could control the rate of flavor delivery into the oral cavity. Using 100% polyethylene glycol 1000 as the soluble substance provides rapid flavor delivery. The low melting point and high solubility of this substance make it desirable to use polyethylene glycol or polyethylene glycol blends at a higher molecular weight to achieve product survivability under either higher heat or higher humidity conditions, which are often seen in delivering products to the shelf. For this reason a mixture of polyethylene glycol 3350 with 5 to 50% polyethylene glycol 1000 is more desirable. The delivery of flavor into the mouth is longer lasting and the product shelf life significantly lengthened.

1. A dental floss device comprising:
a handle; and
a dental floss holder;
said handle having a gripping portion and a head portion; said head portion having opposite engaging surfaces;
said dental floss holder having a base portion and a pair of spaced-apart jaws extending from the base portion to accommodate a length of dental floss there between, the spaced-apart jaws having at least one cavity for adding substances, the base portion having a mating portion for releasable engagement to said handle.

2. A dental floss device of claim 1, wherein the base portion defines a tongue having lateral engaging surfaces, each engaging surface having at least one detent and at least one recess, the detent and recess being laterally spaced apart and aligned with a complementary detent and recess on the opposite engaging surfaces of the head portion of the handle.

3. A dental floss device of claim 1, wherein said handle is integrally connected to the base of the dental floss holder and extends therefrom.

4. A dental floss device of claim 1, wherein said handle comprises a head portion and an elongated portion;
the head portion having a releasable engagement means between the handle and the floss holder for retaining the dental floss holder securely in position on the head portion of the handle during movement of the dental floss device in use;
the head portion further having a portion for receiving said dental floss holder, said head portion having a transversely extending groove defined by a floor, lateral receiving walls, and terminal snap fit recessions, each of said receiving walls having at least one detent and at least one recess, the detent and recess being laterally spaced apart and aligned with a complementary detent and recess on the other receiving wall;
wherein, on assembly, the tongue of the dental floss holder engages the transversely extending groove and the lateral engaging surfaces contact the lateral receiving walls to define the releasable engagement means, and the snap fit projections of the spaced-apart jaws engage the terminal snap fit recessions of the head portion to constitute snap fitting means.

5. A dental floss device of claim 1, wherein said handle is made of a polypropylene material.

6. A dental floss device of claim 1, wherein said dental floss holder is made of a polypropylene material.

7. A dental floss device of claim 1, wherein said handle is made of a co-polyester material.

8. A dental floss device comprising:
a base portion; and
a pair of spaced-apart arms extending from the base portion to accommodate a length of dental floss therebetween,
each of said pair of spaced-apart arms having a surface, the surface of at least one of said arms comprising a cavity capable of containing a flavored substance, an active or a combination of a flavored substance and an active.

9. The dental floss device of claim 8, wherein said cavity is on a lateral surface of said arm, the cavity extending through the arm to form a through hole.

10. The dental floss device of claim 8, wherein said cavity contains a flavored substance.

11. The dental floss device of claim 8, wherein said cavity contains an active.

12. The dental floss device of claim 10, wherein said flavored substance is water soluble.

13. The dental floss device of claim 10, wherein said flavored substance is water insoluble.

14. The dental floss device of claim 11, wherein said actives are saliva soluble.

15. The dental floss device of claim 11, wherein said actives are insoluble.

16. The dental floss device of claim 9, wherein said through hole contain a tapered section that increases in diameter away from the surface of said cavity.

17. The dental floss device of claim 11, wherein said active is a chemotherapeutic agent.

18. The dental floss device of claim 8, wherein said length of dental floss is a multi-filament yarn.

19. The dental floss device of claim 8, wherein said length of dental floss is a psuedo-monofilament yarn.

21. A dental device comprising:
a handle; and
a dental article;
said handle having a gripping portion and a head portion; the head portion containing one side of a releasable engagement;
said dental article having a mating portion for releasable engagement with said handle and at least one cavity capable of releasably retaining a flavor substance, an active or a combination of a flavor substance and an active.

22. A dental device of claim 17, wherein said head portion having a portion for receiving said dental article, said head portion having a transversely extending groove defined by a floor, lateral receiving walls, and terminal snap fit recessions, each of said receiving walls having at least one detent and at least one recess, the detent and recess being laterally spaced apart and aligned with a complementary detent and recess on the other receiving wall.

23. A dental article having means for delivering a flavor and/or a chemotherapeutic substance to an oral cavity in use, said article being formed from an injection molded plastic, said article having at least one cavity, said at least one cavity being filled with a heat meltable polymer which is solid at room temperature and capable of melting when placed in the mouth and contacted with saliva, said heat meltable polymer containing said flavor and/or chemotherapeutic substance, whereby said flavor and/or chemotherapeutic substance is delivered to the oral cavity.
